(19) United States
(12) Patent Application Publication
(10) Pub. No.: US 2023/0415581 A1
(43) Pub. Date: Dec. 28, 2023

(54) VEHICLE, A METHOD OF CONTROLLING A VEHICLE, AND A METHOD OF CONTROLLING VEHICLE BRAKING

(71) Applicants: HYUNDAI MOTOR COMPANY, Seoul (KR); KIA CORPORATION, Seoul (KR)

(72) Inventors: Joon Shik Park, Seoul (KR); Yong Hoon Lee, Seoul (KR); Ickhwan Kim, Bucheon-si (KR)

(73) Assignees: HYUNDAI MOTOR COMPANY, Seoul (KR); KIA CORPORATION, Seoul (KR)

(21) Appl. No.: 18/076,158

(22) Filed: Dec. 6, 2022

(30) Foreign Application Priority Data
Jun. 27, 2022 (KR) 10-2022-0078162

(51) Int. Cl. B60L 7/26; B60T 7/08; B60T 8/32

(52) U.S. Cl. CPC B60L 7/26; B60T 7/085; B60T 8/3215; B60L 2250/28; B60K 20/06

(57) ABSTRACT

A method of controlling vehicle braking includes decelerating a vehicle to a first speed by using regenerative braking when a vehicle stop request is generated by a manipulation of a paddle shifter, stopping the vehicle by using hydraulic braking when the vehicle is decelerated to the first speed, and maintaining a stopped state of the vehicle by automatic vehicle hold control when the vehicle is stopped.

### CROSS-REFERENCE TO RELATED APPLICATION(S)

This application claims the benefit of priority to Korean Patent Application No. 10-2022-0078162, filed on Jun. 27, 2022 in the Korean Intellectual Property Office, the disclosure of which is incorporated herein by reference.

### TECHNICAL FIELD

The present disclosure relates to a vehicle, and more particularly, to a method of controlling braking of a hybrid or electric vehicle.

### BACKGROUND

Recently, a paddle shifter is mounted on a steering wheel of a vehicle. The paddle shifter is used to perform a gear shift operation on a vehicle or change a regenerative braking step.

A vehicle, such as a hybrid or electric vehicle, which has a motor, may charge a battery while generating a braking force by regenerative braking of the motor.

However, in a case that the hybrid or electric vehicle is stopped only by using the regenerative braking, the vehicle may temporarily move without being completely stopped because of unevenness or inclinations in a road.

### SUMMARY

An aspect of the disclosure is to more securely and stably stop a vehicle by a combination of regenerative braking control, hydraulic braking control, and automatic vehicle hold control.

In accordance with an aspect of the disclosure, a method of controlling vehicle braking includes: decelerating a vehicle to a first speed by using regenerative braking when a vehicle stop request is generated by a manipulation of a paddle shifter; stopping the vehicle by using hydraulic braking when the vehicle is decelerated to the first speed; and maintaining a stopped state of the vehicle by automatic vehicle hold control when the vehicle is stopped.

The method of controlling vehicle braking may include determining that the vehicle stop request is generated when a manipulation of the paddle shifter for braking is continuously performed for a preset time or more.

In the method of controlling vehicle braking, the first speed may be in a range of 0 kph or more and 3 kph or less.

The method of controlling vehicle braking may further include releasing the automatic vehicle hold control when an event, which satisfies a condition for releasing the automatic vehicle hold control, occurs while the stopped state of the vehicle is maintained by the automatic vehicle hold control.

In the method of controlling vehicle braking, the event, which satisfies the condition for releasing the automatic vehicle hold control, may be generated as an accelerator pedal of the vehicle is manipulated.

The method of controlling vehicle braking may include starting the automatic vehicle hold control when the stopped state of the vehicle is maintained for a preset time or more when stopping the vehicle.

In accordance with another aspect of the disclosure, a vehicle includes: a paddle shifter provided on a steering wheel; a motor configured to generate a braking force by regenerative braking; a hydraulic brake configured to generate a braking force by hydraulic braking; and a controller. The controller is configured to decelerate the vehicle to a first speed by using the regenerative braking of the motor when a vehicle stop request is generated by a manipulation of the paddle shifter, to stop the vehicle by using the hydraulic braking of the hydraulic brake when the vehicle is decelerated to the first speed, and to maintain a stopped state of the vehicle by automatic vehicle hold control when the vehicle is stopped.

In the vehicle, the controller may be further configured to determine that the vehicle stop request is generated when the manipulation of the paddle shifter for braking is continuously performed for a preset time or more.

In the vehicle, the first speed may be in a range of 0 kph or more and 3 kph or less.

In the vehicle, the controller may be further configured to release the automatic vehicle hold control when an event, which satisfies a condition for releasing the automatic vehicle hold control, occurs while the stopped state of the vehicle is maintained by the automatic vehicle hold control.

In the vehicle, the event, which satisfies the condition for releasing the automatic vehicle hold control, may be generated as an accelerator pedal of the vehicle is manipulated.

In the vehicle, the controller may be further configured to start the automatic vehicle hold control when the stopped state of the vehicle is maintained for a preset time or more when stopping the vehicle.

In accordance with still another aspect of the disclosure, a method of controlling a vehicle includes: decelerating a vehicle to a first speed by using regenerative braking of a motor when a vehicle stop request is generated by a manipulation of a paddle shifter; stopping the vehicle by using hydraulic braking of a hydraulic brake when the vehicle is decelerated to the first speed; maintaining a stopped state of the vehicle by automatic vehicle hold control when the vehicle is stopped; and releasing the automatic vehicle hold control and accelerating the vehicle when an accelerator pedal is manipulated to accelerate the vehicle while the stopped state of the vehicle is maintained by the automatic vehicle hold control.

The method of controlling a vehicle may include determining that the vehicle stop request is generated when a manipulation of the paddle shifter for braking is continuously performed for a preset time or more.

In the method of controlling a vehicle, the first speed may be in a range of 0 kph or more and 3 kph or less.

The method of controlling a vehicle may include starting the automatic vehicle hold control when the stopped state of the vehicle is maintained for a preset time or more when stopping the vehicle.

### BRIEF DESCRIPTION OF THE DRAWINGS

These and/or other aspects of the disclosure should become apparent and more readily appreciated from the following description of the embodiments, taken in conjunction with the accompanying drawings of which:

FIG. 1 is a view illustrating an interior of a vehicle according to an embodiment of the present disclosure;

FIG. 2 is a view illustrating a steering wheel on which a paddle shifter of the vehicle according to an embodiment of the present disclosure is mounted;

FIG. 3 is a view illustrating a control system of the vehicle according to an embodiment of the present disclosure;

FIGS. 4A and 4B are views illustrating a method of controlling a vehicle according to an embodiment of the present disclosure; and

FIG. 5 is a view illustrating operating characteristics of main devices of the vehicle according to an embodiment of the present disclosure that is implemented by the controls in FIGS. 4A and 4B.

### DETAILED DESCRIPTION

Throughout the specification, the same reference numerals denote the same constituent elements. This specification does not describe all elements of the disclosed embodiments. Further, detailed descriptions of what is well known in the art or redundant descriptions on substantially the same configurations have been omitted. The terms ‘part,’ ‘module,’ ‘member,’ ‘block,’ and the like as used in the specification may be implemented in software or hardware. Further, a plurality of ‘part,’ ‘module,’ ‘member,’ ‘block,’ and the like may be embodied as one component. It is also possible that one ‘part,’ ‘module,’ ‘member,’ ‘block,’ and the like includes a plurality of components.

Throughout the present specification, when one constituent element is referred to as being “connected to” another constituent element, one constituent element can be “directly connected to” the other constituent element, and one constituent element can also be “indirectly connected to” the other constituent element. The indirect connection includes a connection through a wireless communication network. In addition, unless explicitly described to the contrary, the words “comprise,” have,” or “include” and variations, such as “comprises,” “comprising,” “has,” “having,” “includes,” or “including,” should be understood to imply the inclusion of stated constituent elements, not the exclusion of any other constituent elements. The terms first, second, and the like are used to distinguish one component from another component, and the component is not limited by such terms described herein. An expression used in the singular encompasses the expression of the plural, unless it has a clearly different meaning when taken in context. When a component, device, element, or the like of the present disclosure is described as having a purpose or performing an operation, function, or the like, the component, device, or element should be considered herein as being “configured to” meet that purpose or to perform that operation or function.

The reference numerals used in operations are used for descriptive convenience and are not intended to describe the order of operations and the operations may be performed in a different order unless otherwise stated.

Hereinafter, embodiments of the disclosure are described in detail with reference to the accompanying drawings.

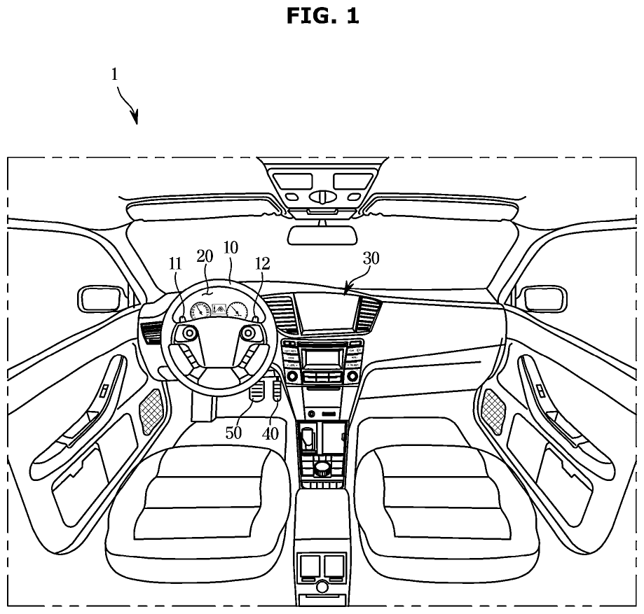

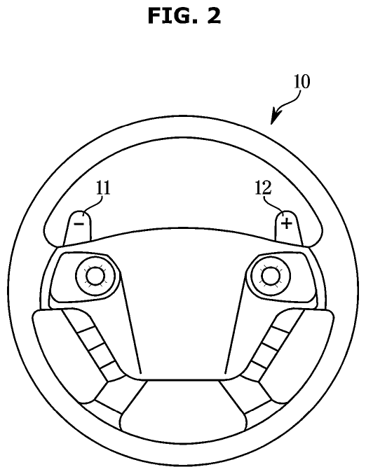

FIG. 1 is a view illustrating an interior of a vehicle according to an embodiment of the present disclosure. FIG. 2 is a view illustrating a steering wheel on which a paddle shifter of the vehicle according to an embodiment of the present disclosure is mounted.

As illustrated in FIGS. 1 and 2, a vehicle 1 may include a steering wheel 10, paddle shifters 11 and 12, a display 20, a user interface device 30, an accelerator pedal 40, and a brake pedal 50. The display 20 and the user interface device 30 may be disposed on a dashboard. The display 20 may be called a cluster.

The steering wheel 10 enables a user to change a traveling direction of the vehicle 1. The paddle shifters 11 and 12 may each be provided in various forms (e.g., a lever or a switch) and disposed on the steering wheel 10. The paddle shifters 11 and 12 may include a first paddle shifter 11 and a second paddle shifter 12. As illustrated in FIG. 2 in detail, the first paddle shifter 11 may be provided at a left side of the steering wheel 10, and the second paddle shifter 12 may be provided at a right side of the steering wheel 10. Therefore, a driver may manipulate the first paddle shifter 11 with the left hand and manipulate the second paddle shifter 12 with the right hand in a state in which the driver grips the steering wheel 10. The driver may manipulate the paddle shifters 11 and 12 by pulling the paddle shifters 11 and 12 toward the driver's body.

The first paddle shifter 11 and the second paddle shifter 12 may be used to adjust gear shift positions or adjust braking force (regenerative braking). In the case of the vehicle 1 including a transmission, the driver may lower a gear stage (−) by pulling the first paddle shifter 11 to change (gear shift) the gear stage of the transmission, and the driver may raise the gear stage (+) by pulling the second paddle shifter 12. The paddle shifters 11 and 12 may be used to adjust a braking force implemented by the regenerative braking of the vehicle 1. The driver increases the braking force by pulling the first paddle shifter 11 and the driver decreases the braking force by pulling the second paddle shifter 12.

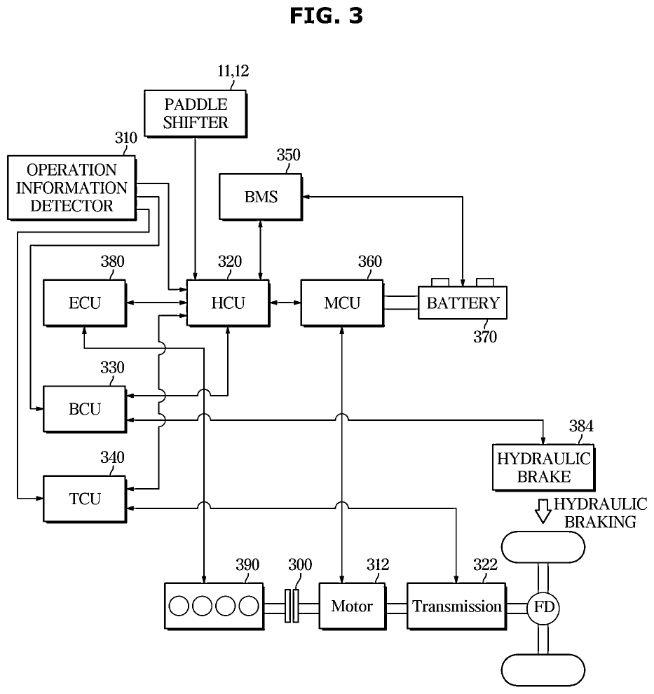

FIG. 3 is a view illustrating a control system of the vehicle according to an embodiment of the present disclosure. The example is described in which the vehicle 1 according to an embodiment of the present disclosure is a hybrid vehicle having both an internal combustion engine and a motor. However, the present disclosure may also be applied to a general electric vehicle having only a motor without having an internal combustion engine.

As illustrated in FIG. 3, the vehicle 1 according to an embodiment of the present disclosure includes an engine 390, a motor 312, an engine clutch 300, a transmission 322, a motor control unit (MCU) 360, and a battery 370.

The engine 390 and the motor 312 are power sources that generate power for driving the vehicle 1. The battery 370 is an electric power source for the motor 312 and supplies electric power to the motor 312 through an inverter (not illustrated) in the MCU 360. The battery 370 may supply electric power to the motor 312 through the inverter in the MCU 360 (until the battery is discharged). On the contrary, the battery 370 may be supplied with electric power from the motor 312 and the inverter in the MCU 360 (to charge the battery). The inverter in the MCU 360 converts direct current of the battery 370 into multi-phase alternating current (e.g., three-phase alternating current) and supplies the alternating current to the motor 312 to operate the motor 312.

In FIG. 3, an operation information detector 310 may include an accelerator position sensor (APS) (not illustrated), a brake pedal sensor (BPS) (not illustrated), and a vehicle speed detector (not illustrated). The operation information detector 310 receives information on a position of the accelerator pedal from the APS. It is possible to identify whether the driver manipulates the accelerator pedal based on the information on the position of the accelerator pedal received from the APS. The operation information detector 310 receives information on a speed of the vehicle 1 from the vehicle speed detector. The operation information detector 310 is connected to a hybrid control unit (HCU) 320, a brake control unit (BCU) 330, and a transmission control unit (TCU) 340 to communicate with the HCU 320, the BCU 330, and the TCU 340. The operation information detector 310 also receives detected values from the HCU 320, the BCU 330, and the TCU 340. The BCU 330 may include an integrated electronic brake (IEB) (not illustrated).

The engine clutch 300 is interposed between the engine 390 and the motor 312. The engine clutch 300 is engaged or disengaged by hydraulic pressure and connects the engine 390 and the motor 312 so that power is transmitted between the engine 390 and the motor 312. Further, the engine clutch 300 disconnects the engine 390 and the motor 312 so that power cannot be transmitted between the engine 390 and the motor 312.

The transmission 322 is connected to an output side of the motor 312. The transmission 322 converts power from the motor 312 or composite power from the engine 390 and the motor 312 and transmits the power to a driving wheel through a driving shaft. An automatic transmission (AT) or a dual-clutch transmission (DCT) may be used as the transmission 322.

In addition, the HCU 320, which is a high-level controller for controlling an overall operation of the vehicle 1, may be mounted in the vehicle 1. The vehicle 1 may have various controllers for controlling various types of devices of the vehicle 1.

For example, the vehicle 1 includes an engine control unit (ECU) 380 configured to control an operation of the engine 390, the MCU 360 configured to control an operation of the motor 312 and the regenerative braking, the TCU 340 configured to control an operation of the transmission 322, and a battery management system (BMS) 350. The BMS 350 is configured to collect battery state information and use the battery state information to charge or discharge the battery 370 or provide the battery state information to another controller. Further, the BMS 350 is configured to manage the battery 370.

The HCU 320, the ECU 380, the MCU 360, the TCU 340, and the BMS 350 communicate with one another through a control area network (CAN) and perform cooperative control on the devices in the vehicle 1. To this end, a high-level controller generates a control instruction by collecting various types of information from low-level controllers and transmits the generated control instruction to the low-level controllers.

In addition, a control process of the present disclosure may be performed as the plurality of controllers such as the HCU 320, the BCU 330, the TCU 340, the BMS 350, and the MCU 360 perform cooperative control. In addition, the control process of the present disclosure may be performed by a single controller in which all the functions of the plurality of controllers are integrated. In the following description, the ‘controller’ may be the HCU 320, i.e., the highest-level controller among the HCU 320, the BCU 330, the TCU 340, the BMS 350, and the MCU 360. Alternatively, the ‘controller’ may be at least one of the HCU 320, the BCU 330, the TCU 340, the BMS 350, and the MCU 360. Alternatively, the ‘controller’ may be a single controller in which all the functions of the HCU 320, the BCU 330, the TCU 340, the BMS 350, and the MCU 360 are integrated.

A hydraulic brake 384 may be connected to the brake pedal disposed in the vehicle 1. The hydraulic brake 384 may generate a braking force in response to a pedal effort applied to the brake pedal, thereby reducing a rotational force of a vehicle wheel. When the pedal effort is applied to the brake pedal, a braking signal having a magnitude corresponding to the pedal effort is inputted to the HCU 320. Hydraulic torque of the hydraulic brake 384 may be adjusted based on the magnitude of the braking signal inputted to the HCU 320.

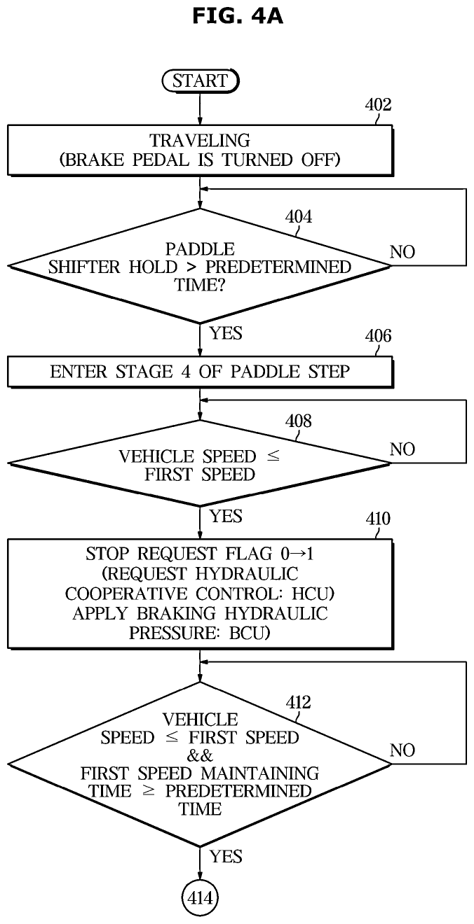

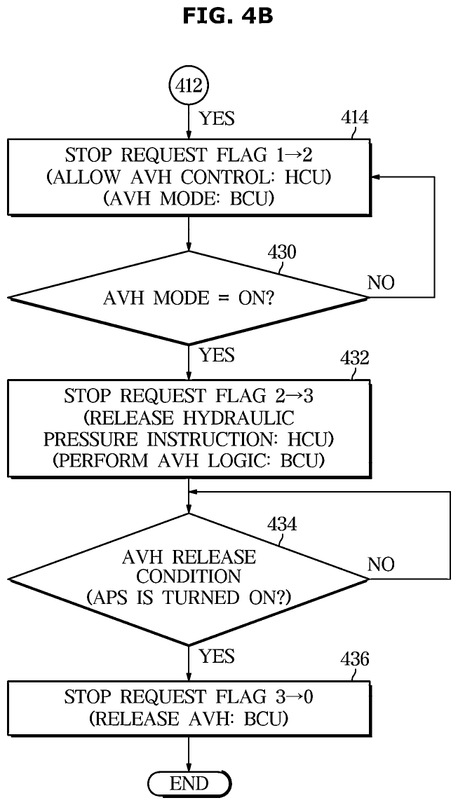

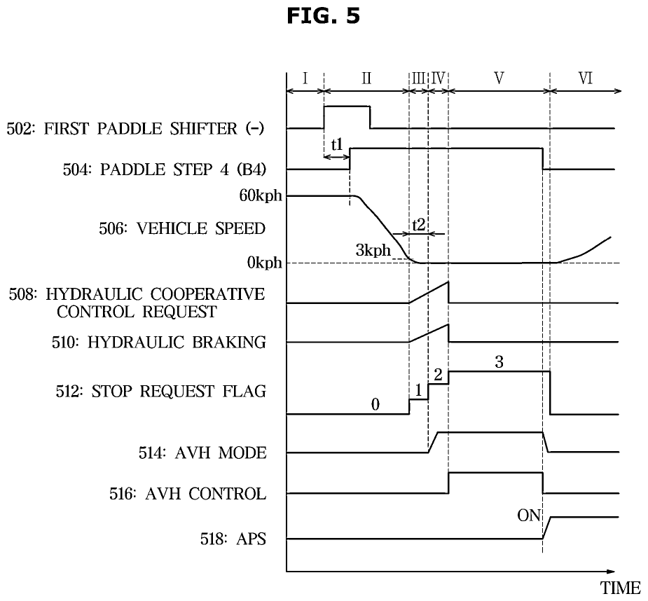

FIGS. 4A and 4B are views illustrating a method of controlling a vehicle according to an embodiment of the present disclosure. Operation 412 in FIG. 4A is connected to block or step 414 in FIG. 4B. FIG. 5 is a view illustrating operating characteristics of main devices of the vehicle according to an embodiment of the present disclosure that is implemented by the controls in FIGS. 4A and 4B.

As illustrated in FIG. 4A, when the driver turns on the vehicle 1 (ignition on or power on) and manipulates the accelerator pedal 40, the vehicle 1 travels at a predetermined speed in response to the manipulation of the accelerator pedal 40 (operation 402). In this case, for example, a speed of the vehicle 1 may be 60 kph (section ‘I’ in FIG. 5). In this case, the state of the vehicle 1 is a ‘braking off’ state when the driver does not press the brake pedal.

When the vehicle 1 travels at a speed of 60 kph, the driver may hold the first paddle shifter 11 to generate the braking force by the regenerative braking (operation 404). The operation of holding the first paddle shifter 11 means that the state in which the driver pushes (or pulls) the first paddle shifter 11 is maintained for a predetermined time. It can be seen that the hold state of the first paddle shifter 11 is maintained for a preset time t1 or more in section ‘II’ in FIG. 5.

When the hold time of the first paddle shifter 11 is maintained for the preset time t1 or more (operation 404: YES), the HCU 320 switches the paddle step to stage 4 for a complete stop among a predetermined plurality of stages 1 to 4 of the paddle step (operation 406). In other words, as the driver holds the first paddle shifter 11 for the preset time t1 or more, the paddle step may enter stage 4 of the paddle step in which the vehicle 1 may be decelerated to a first speed by means of the regenerative braking. In an embodiment of the present disclosure, the vehicle 1 is considered as being in a stopped state when a speed of the vehicle 1 reaches a range of the first speed. In an embodiment of the present disclosure, the first speed may be in a range of 0 kph or more and 3 kph or less. It can be seen that the paddle step switches to stage 4 in section ‘II’ in FIG. 5. After the vehicle 1 switches to stage 4 of the paddle step, stage 4 of the paddle step is continuously maintained even though the driver does not hold the first paddle shifter 11 any further.

When the vehicle 1 is decelerated to the first speed by the regenerative braking after the vehicle 1 switches to stage 4 of the paddle step (operation 408: YES), the HCU 320 switches a stop request flag from ‘0’ to ‘1’ (operation 410). In FIG. 5, it can be seen that the stop request flag 512 switches from ‘0’ in sections ‘I’ and ‘II’ to ‘1’ in section ‘III’. The HCU 320 request hydraulic cooperative control from the BCU 330 by switching the stop request flag from ‘0’ to ‘1’. It can be seen in FIG. 5 that hydraulic cooperative control request 508 is activated in section ‘III’ and section ‘IV’. The BCU 330 generates a hydraulic braking force by controlling the hydraulic brake 384 in response to the request for the hydraulic cooperative control from the HCU 320. It can be seen that a hydraulic braking force 510 is generated in section ‘III’ and section ‘IV’ in FIG. 5.

As described herein, in an embodiment of the present disclosure, only the regenerative braking of the motor 312 is used to brake the vehicle 1 in response to the hold state of the paddle shifter 11 for the preset time. When the vehicle 1 is decelerated to the first speed (e.g., 0 to 3 kph) by the regenerative braking, additional hydraulic braking more stably stops the vehicle 1. In other words, in an embodiment of the present disclosure, it is possible to more securely and completely stop the vehicle 1 by generating the hydraulic braking in addition to the regenerative braking. Generating the hydraulic braking in addition to the regenerative braking is advantageous to prepare for a situation in which the vehicle 1 is finely moved or pushed forward or rearward without being completely stopped only by the regenerative braking of the motor 312 because a road surface at a position at which the vehicle 1 is stopped is not flat or has unevenness or an inclination.

In an embodiment of the present disclosure, the vehicle 1 is considered as being stopped when the vehicle 1 is maintained at the first speed for the preset time (t2 in FIG. 5) or more. Therefore, when the vehicle 1 is maintained at the first speed for the preset time t2 or more (operation 412: YES), the HCU 320 allows automatic vehicle hold control by switching the stop request flag from ‘1’ to ‘2’. The BCU 330 switches the vehicle 1 to an automatic vehicle hold mode in response to the allowance of the automatic vehicle hold control of the HCU 320 (operation 414). In FIG. 5, it can be seen that the automatic vehicle hold mode 514 is activated as the stop request flag switches from ‘1’ in section ‘III’ to ‘2’ in section ‘IV’. In the automatic vehicle hold mode, a stopped state of the vehicle 1 is maintained even though the driver takes the foot off the brake pedal 50 in the state in which, i.e., when the vehicle 1 is stopped.

In FIG. 4B, when the vehicle 1 enters the automatic vehicle hold mode (operation 430: YES), the HCU 320 release a hydraulic instruction by switching the stop request flag from ‘2’ to ‘3’, and the BCU 330 performs the automatic vehicle hold (operation 432). In FIG. 5, it can be seen that the automatic vehicle hold control 516 is performed in section ‘V’ as the stop request flag switches from ‘2’ in section ‘IV’ to ‘3’ in section ‘V’. In other words, according to an embodiment of the present disclosure, vehicle 1 may completely stop by primarily decelerating using the regenerative braking of the motor 312 and performing the hydraulic braking. In addition, the automatic vehicle hold control is performed after the vehicle 1 is completely stopped, such that the stopped state of the vehicle 1 is maintained even though the driver takes the foot off the brake pedal 50. Therefore, at the time of moving the vehicle 1, again after the vehicle 1 has stopped, the hydraulic braking is released and the vehicle 1 moves again in the state in which, i.e., when the automatic vehicle hold control is performed. Therefore, it is very easy to map gradients with respect to hydraulic pressure and tune a torque application point in time at the time of designing the vehicle.

When a condition for releasing the automatic vehicle hold occurs in the state in which the vehicle 1 is in the automatic vehicle hold state (operation 434: YES), the HCU 320 switches the stop request flag from ‘3’ to ‘0’ and the BCU 330 releases the automatic vehicle hold state in response to the switching of the stop request flag from ‘3’ to ‘0’ (operation 436). For example, the condition for releasing the automatic vehicle hold may mean that the driver manipulates the accelerator pedal 40 (applies the pedal effort). In section ‘VI’ in FIG. 5, when the manipulation of the accelerator pedal 40 by the user is detected by an acceleration position sensor (APS) 518 that detects a position of the accelerator pedal 40, the stop request flag 512 switches from ‘3’ in section ‘V’ to ‘0’ in section VI in response to the detection, such that stage 4 of the paddle step (complete stop) 504 is ended, and the automatic vehicle hold mode 514 and the automatic vehicle hold control 516 are ended. Therefore, it can be seen that a speed 506 of the vehicle 1 gradually increases from a stop speed to a speed higher than the stop speed.

On the other hand, the herein-described embodiments may be implemented in the form of a recording medium storing instructions executable by a computer. The instructions may be stored in the form of program code. When the instructions are executed by a processor, a program module is generated by the instructions so that the operations of the disclosed embodiments may be carried out. The recording medium may be implemented as a computer-readable recording medium.

The computer-readable recording medium includes all types of recording media storing data readable by a computer system. Examples of the computer-readable recording medium may include a read-only memory (ROM), a random-access memory (RAM), a magnetic tape, a magnetic disc, a flash memory, an optical data storage device, or the like.

The present disclosure is provided to more securely and stably stop the vehicle by a combination of regenerative braking control, hydraulic braking control, and automatic vehicle hold control in case of stopping the vehicle.

As described herein, the embodiments have been described with reference to the accompanying drawings. A person having ordinary skill in the art may understand that the present disclosure may be carried out in other forms different from those disclosed in the embodiments without changing the technical spirit or the essential features of the present disclosure. The disclosed embodiments are illustrative and should not be interpreted as being restrictive.

### DESCRIPTION OF REFERENCE NUMERALS

1: Vehicle
10: Steering wheel
11, 12: Paddle shifter
20: Display
30: User interface device
40: Accelerator pedal
50: Brake pedal
300: Clutch
310: Operation information detector
312: Motor
322: Transmission
320: HCU
330: BCU
340: TCU
350: BMS
360: MCU
370: Battery
380: ECU
384: Hydraulic brake
390: Engine

What is claimed is:

1. A method of controlling vehicle braking, the method comprising:
decelerating a vehicle to a first speed by using regenerative braking when a vehicle stop request is generated by a manipulation of a paddle shifter;
stopping the vehicle by using hydraulic braking when the vehicle is decelerated to the first speed; and
maintaining a stopped state of the vehicle by automatic vehicle hold control when the vehicle is stopped.

2. The method of claim 1, further comprising:
determining that the vehicle stop request is generated when a manipulation of the paddle shifter for braking is continuously performed for a preset time or more.

3. The method of claim 1, wherein the first speed is in a range of 0 kph or more and 3 kph or less.

4. The method of claim 1, further comprising:
releasing the automatic vehicle hold control when an event, which satisfies a condition for releasing the automatic vehicle hold control, occurs while the stopped state of the vehicle is maintained by the automatic vehicle hold control.

5. The method of claim 4, wherein the event, which satisfies the condition for releasing the automatic vehicle hold control, is generated as an accelerator pedal of the vehicle is manipulated.

6. The method of claim 1, further comprising:
starting the automatic vehicle hold control when the stopped state of the vehicle is maintained for a preset time or more in the stopping of the vehicle.

7. A vehicle comprising:
a paddle shifter provided on a steering wheel;
a motor configured to generate a braking force by regenerative braking;
a hydraulic brake configured to generate a braking force by hydraulic braking; and
a controller configured to decelerate the vehicle to a first speed by using the regenerative braking of the motor when a vehicle stop request is generated by a manipulation of the paddle shifter, stop the vehicle by using the hydraulic braking of the hydraulic brake when the vehicle is decelerated to the first speed, and maintain a stopped state of the vehicle by automatic vehicle hold control when the vehicle is stopped.

8. The vehicle of claim 7, wherein the controller is further configured to determine that the vehicle stop request is generated when the manipulation of the paddle shifter for braking is continuously performed for a preset time or more.

9. The vehicle of claim 7, wherein the controller is further configured to set the first speed to be in a range of 0 kph or more and 3 kph or less.

10. The vehicle of claim 7, wherein the controller is further configured to release the automatic vehicle hold control when an event, which satisfies a condition for releasing the automatic vehicle hold control, occurs while the stopped state of the vehicle is maintained by the automatic vehicle hold control.

11. The vehicle of claim 10, wherein the event, which satisfies the condition for releasing the automatic vehicle hold control, is generated as an accelerator pedal of the vehicle is manipulated.

12. The vehicle of claim 7, wherein the controller is further configured to start the automatic vehicle hold control when the stopped state of the vehicle is maintained for a preset time or more in the stopping of the vehicle.

13. A method of controlling a vehicle, the method comprising:
decelerating a vehicle to a first speed by using regenerative braking of a motor when a vehicle stop request is generated by a manipulation of a paddle shifter;
stopping the vehicle by using hydraulic braking of a hydraulic brake when the vehicle is decelerated to the first speed;
maintaining a stopped state of the vehicle by automatic vehicle hold control when the vehicle is stopped; and
releasing the automatic vehicle hold control and accelerating the vehicle when an accelerator pedal is manipulated to accelerate the vehicle while the stopped state of the vehicle is maintained by the automatic vehicle hold control.

14. The method of claim 13, further comprising:
determining that the vehicle stop request is generated when a manipulation of the paddle shifter for braking is continuously performed for a preset time or more.

15. The method of claim 13, wherein the first speed is in a range of 0 kph or more and 3 kph or less.

16. The method of claim 13, further comprising:
starting the automatic vehicle hold control when the stopped state of the vehicle is maintained for a preset time or more in the stopping of the vehicle.
